(19) United States
(12) Patent Application Publication
(10) Pub. No.: US 2013/0002139 A1
(43) Pub. Date: Jan. 3, 2013

(54) SEMICONDUCTOR LIGHT EMITTING DEVICE PACKAGE

(75) Inventors: Tae Hun KIM, Anyang (KR); Seung Wan Chae, Yongin (KR); Sung Tae Kim, Seoul (KR); Su Yeol Lee, Seongnam (KR)

(73) Assignee: SAMSUNG ELECTRONICS CO., LTD.

(21) Appl. No.: 13/536,338

(22) Filed: Jun. 28, 2012

(30) Foreign Application Priority Data
Jun. 29, 2011 (KR) 10-2011-0063806

(51) Int. Cl. H05B 37/02

(52) U.S. Cl. 315/121; 315/201

(57) ABSTRACT

There is provided a semiconductor light emitting device package including: a semiconductor substrate having a first principal surface and a second principal surface opposed thereto; a light source disposed on a first principal surface side of the semiconductor substrate; a plurality of electrode pads disposed on a second principal side of the semiconductor substrate; a conductive via extended from the plurality of electrode pads and penetrating the semiconductor substrate; and a driving circuit unit including a plurality of diodes obtained through a pn junction formed by a p-type region and an n-type region, and electrically connected to the conductive via and the light source.

### CROSS-REFERENCE TO RELATED APPLICATIONS

This application claims the priority of Korean Patent Application No. 10-2011-0063806 filed on Jun. 29, 2011, in the Korean Intellectual Property Office, the disclosure of which is incorporated herein by reference.

### BACKGROUND OF THE INVENTION

1. Field of the Invention

The present invention relates to a semiconductor light emitting device package.

2. Description of the Related Art

A light emitting diode (LED), a semiconductor light source, is a semiconductor device capable of generating various colors of light through the recombination of electrons and holes at a junction between a p-type semiconductor layer and an n-type semiconductor layer when current is applied thereto. Such LEDs have strengths as light sources in terms of long lifespans, relatively low power consumption, excellent initial driving properties, relatively high oscillation resistance, and the like, as compared with a light source based on a filament, and therefore, demand therefor has continuously increased.

Since such an LED may be driven by a relatively low voltage, it may be used as an illumination device by connecting a plurality of LEDs in series to commercial alternating current. In this case, however, a rate of variations in current generated through interaction between heat generated from the device itself and heat generated through a serial connection between devices may be high, and voltage may not be uniformly distributed. Thus, in this case, devices may be damaged due to a momentary inverse voltage. In order to solve these defects, research into including a rectifying circuit, a zener diode, and the like, in a driving circuit, or the like, has been continuously undertaken, but there is also complexity in a circuit structure and production costs and package size may be increased.

Accordingly, design of an AC driven-type semiconductor light emitting device package having a significantly reduced size while being usable with AC power, small fabrication costs, low defect rates and the ability to be mass produced has been demanded.

### SUMMARY OF INVENTION

An aspect of the present invention provides a semiconductor light emitting device package having a small sized and an integrated structure by integrating a rectification circuit and other driving circuit provided to drive light emitting devices in an inner portion of a semiconductor substrate.

According to an aspect of the present invention, there is provided a semiconductor light emitting device package including: a semiconductor substrate having a first principal surface and a second principal surface opposed thereto; a light source disposed on a first principal surface side of the semiconductor substrate; a plurality of electrode pads disposed on a second principal surface side of the semiconductor substrate; a conductive via extended from the plurality of electrode pads and penetrating the semiconductor substrate from the second principal surface thereof to the first principal surface thereof; and a driving circuit unit including a plurality of diodes obtained through a pn junction formed by a p-type region having a relatively high concentration of a p-type impurity and an n-type region having a relatively high concentration of an n-type impurity, and electrically connected to the conductive via and the light source to thus rectify an alternating current (AC) current flowing through the plurality of electrode pads and supply the rectified current to the light source.

All regions of the semiconductor substrate may be formed of the n-type region except for the p-type region thereof.

In the semiconductor substrate, at least a portion thereof, except for the p-type region, may be a region not doped with an impurity.

At least a portion of a surface of the semiconductor substrate may be provided with a reflective layer reflecting at least a portion of light emitted from the light source.

The reflective layer may be formed on a surface of the semiconductor substrate, except for in a region in which an insulator is formed.

At least part of the plurality of diodes may be exposed to the outside through the first principal surface.

At least portions of the plurality of diodes may be electrically connected to one another through a wiring structure provided on the first principal surface of the semiconductor substrate.

The light source may be a light emitting device including an n-type semiconductor layer, a p-type semiconductor layer, an active layer interposed therebetween, an n-side electrode electrically connected to the n-type semiconductor layer, and a p-side electrode electrically connected to the p-type semiconductor layer.

The n-side electrode may be electrically connected to at least one p-type region of the plurality of diodes, and the p-side electrode may be electrically connected to at least one n-type region of the plurality of diodes.

The n-side and p-side electrodes and the diodes may be electrically connected to each other through the wiring structure provided on the first principal surface of the semiconductor substrate.

The light source may include a plurality of semiconductor light emitting devices electrically connected to one another.

The plurality of semiconductor light emitting devices may be mounted within a single integrated circuit.

The semiconductor substrate may include at least one of Si and SiC.

The semiconductor substrate may include an insulator formed on at least a portion of the surface thereof.

The semiconductor light emitting device package may further include an insulator interposed between the semiconductor substrate and the conductive via.

The semiconductor light emitting device package may further include an insulator penetrating the semiconductor substrate in a thickness direction thereof to separate between the plurality of diodes.

The semiconductor light emitting device package may further include a capacitor unit including a dielectric layer formed in an inner portion of the semiconductor substrate and connected to the light source in parallel.

In this case, the capacitor unit may be spaced apart from another region of the semiconductor substrate via an insulating layer.

The capacitor unit and the light source may be electrically connected to each other through the wiring structure provided on the first principal surface.

The semiconductor light emitting device package may further include an electrostatic discharge protection circuit connected to the light source in parallel.

In this case, the electrostatic discharge protection circuit may include a zener diode formed in the inner portion of the semiconductor substrate.

In this case, the zener diode may be spaced apart from another region of the semiconductor substrate by the insulating layer.

In this case, the semiconductor substrate may include a cavity having a form in which a portion thereof has been removed from the first principal surface, and the light source may be disposed in the cavity.

The semiconductor light emitting device package may further include a reflective layer formed on an inner wall of the cavity.

In this case, the cavity may have a width increased away from the first principal surface.

The conductive via may be provided in an amount equal to the amount of the plurality of diodes so as to have one-to-one electrical connectivity therebetween.

The plurality of electrode pads may be disposed to be equal to the amount of the conductive vias to have one-to-one electrical connectivity therebetween.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a plan view schematically showing a semiconductor light emitting device package according to an embodiment of the present invention;

FIG. 2 is a cutaway cross-sectional view taken along line A-A′ of FIG. 1;

FIG. 3 is a circuit diagram schematically showing an electrical connection relationship between internal parts of a semiconductor light emitting device package of FIG. 1;

FIG. 4 is a circuit diagram schematically showing an electrical connection relationship in a semiconductor light emitting device package according to another embodiment of the present invention;

FIG. 5 is a schematic cross-sectional view of a semiconductor light emitting device package according to another embodiment of the present invention;

FIG. 6 is a schematic cross-sectional view of a semiconductor light emitting device package according to another embodiment of the present invention;

FIG. 7 is a circuit diagram schematically showing an electrical connection relationship between internal parts in a semiconductor light emitting device package of FIG. 6;

FIG. 8 is a schematic cross-sectional view of a semiconductor light emitting device package according to another embodiment of the present invention;

FIG. 9 is a circuit diagram schematically showing an electrical connection relationship between internal parts of a semiconductor light emitting device package of FIG. 8; and

FIG. 10 is a schematic cross-sectional view of a semiconductor light emitting device package according to another embodiment of the present invention.

### DETAILED DESCRIPTION OF THE EMBODIMENTS

The embodiments of the present invention may be modified to have many different forms and the scope of the invention should not be seen as being limited to the embodiments set forth herein. The embodiments of the present invention are provided so that those skilled in the art may understand the present invention. In the drawings, the shapes and dimensions may be exaggerated for clarity, and the same reference numerals will be used throughout to designate the same or like components.

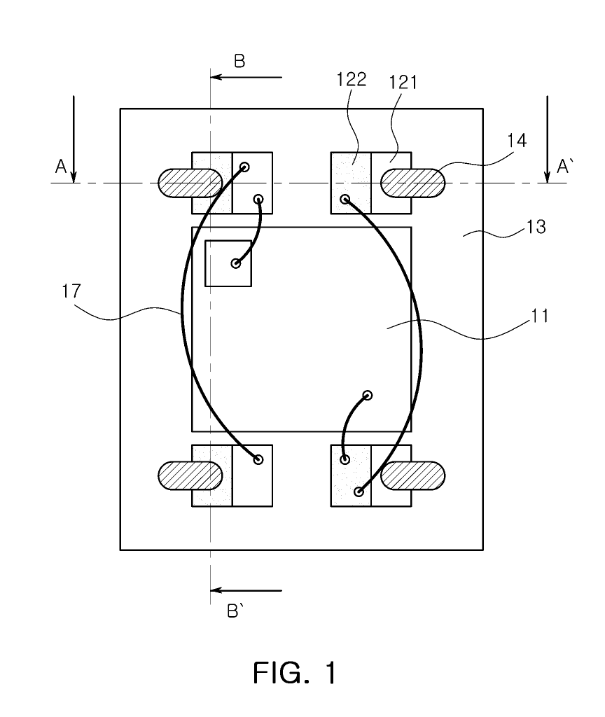

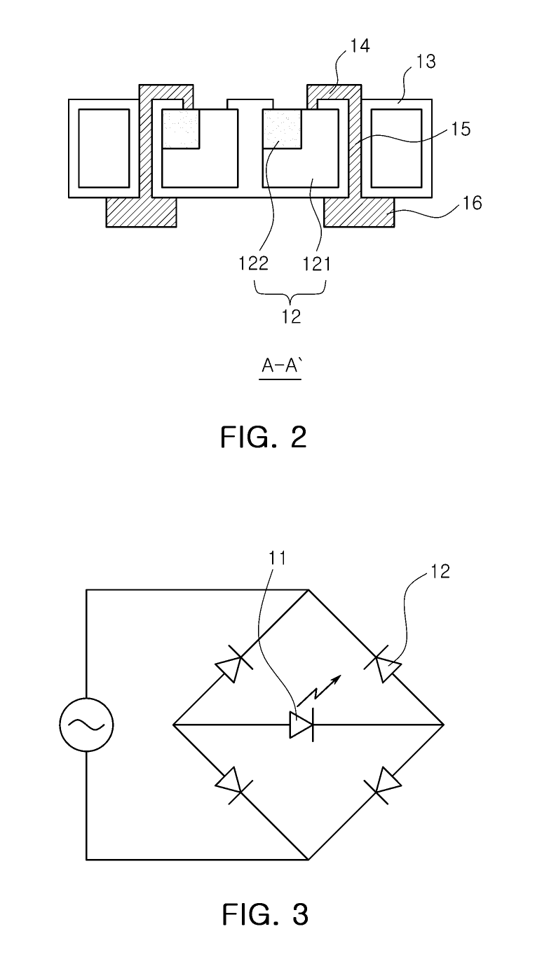

FIG. 1 is a plan view schematically showing a semiconductor light emitting device package according to an embodiment of the present invention. FIG. 2 is a cutaway cross-sectional view taken along line A-A′ of FIG. 1. FIG. 3 is a circuit diagram schematically showing an electrical connection relationship between internal parts of a semiconductor light emitting device package of FIG. 1.

With reference to FIGS. 1 and 2, a semiconductor light emitting device package according to an embodiment of the present invention may include a semiconductor substrate 12, a semiconductor light emitting device 11 mounted on an upper surface of the semiconductor substrate 12, a semiconductor electrode pad 16 formed on a lower surface of the semiconductor substrate 12, a conductive via 15 extended from the electrode pad 16 to penetrate the semiconductor substrate 12 in a thickness direction, and a conductive wire 17 electrically connecting the semiconductor light emitting device 11 to a partial region of the semiconductor substrate 12. In the present embodiment, specifically, the semiconductor substrate 12 may be formed of a silicon semiconductor substrate such that a driving circuit unit for driving the semiconductor light emitting device 11 is provided in an inner portion thereof, and the conductive via 15 may serve to electrically connect the electrode pad 16 to the driving circuit unit. Hereinafter, constituent parts configuring a semiconductor light emitting device will be described in detail. However, in the present specification, the terms ‘upper surface’, ‘lower surface, ‘lateral surface’, and the like will be provided based on the drawings, but may actually vary according to a direction in which the device is disposed in use.

The semiconductor substrate 12 may have first and second principal surfaces opposed to each other. The semiconductor light emitting device 11 may be disposed on the first principal surface, and the electrode pad 16 may be disposed on the second principal surface. The conductive via 15 may be formed to penetrate from the first principal surface to the second principal surface. In addition, according to the present embodiment of the present invention, a driving circuit unit for driving the semiconductor light emitting device 11 may be provided in an inner portion of the semiconductor substrate 12, and hereinafter, the driving circuit unit will be described in detail.

In the driving circuit unit, an n-type semiconductor region 121 may be formed by doping a partial region of the substrate 12 with an n-type impurity, and another portion thereof may be formed as a p-type semiconductor region 122 by doping a p-type impurity thereon, and also, the n-type and p-type semiconductor regions 121 and 122 may contact each other to thus embody a pn junction thereof and form a diode.

In the case in which the diode is formed, the size and number thereof may be applied according to necessity in design, but in a case in which a plurality of diodes are formed, a plurality of pn junctions in which the n-type and p-type semiconductor regions 121 and 122 contact each other on the semiconductor substrate 12 may be respectively formed and may be spaced apart from one another by an insulator to be described later, simultaneously with being electrically isolated from one another, whereby the plurality of diodes may be implemented. In particular, in a case in which a bridge rectifying circuit is configured similarly to that of the present embodiment, four diodes may be formed in appropriate positions on the semiconductor substrate 11.

Meanwhile, although the n-type and p-type semiconductor regions 121 and 122 may be formed in a scheme of implanting n-type and p-type impurities into certain regions as necessary, according to respective embodiments of the invention, specifically, similarly to the present embodiment, the entire semiconductor substrate 12 may be doped with an n-type impurity to allow the semiconductor substrate to be formed as the n-type semiconductor region 121, and a p-type impurity may be selectively doped on a portion to be provided as the p-type semiconductor region 122, whereby a diode may be formed.

In addition, the present embodiment provides a case in which the p-type semiconductor region 122 is formed from a semiconductor upper surface to a predetermined depth therein, but is not limited thereto, and thus, a depth, a range, doping concentration, or the like, in a diode formation region may be variably implemented by those having ordinary skill in the art according to an appropriate circuit configuration.

As such, in the present embodiment, a plurality of diodes may be formed in an inner portion of the semiconductor substrate 11, and a driving circuit unit having a rectifying function may be formed through an appropriate electrical connection using power, the semiconductor light emitting device 11 and the plurality of diodes to be described later may be provided. In this case, the diodes configuring the circuit unit are formed by doping partial regions of the semiconductor substrate 12 with n-type and p-type impurities to form the n-type and p-type semiconductor regions 121 and 122 and contacting the n-type and p-type semiconductor regions 121 and 122 to thereby form a diode, rather than simply inserting diodes into or mounting diodes on an inner portion of the semiconductor substrate 12. Therefore, since the configuration in which the semiconductor substrate 12 itself serves to perform a role of a driving circuit may be implemented without adding a separate device to the exterior thereof, a fabrication process may be simplified and an overall size of the package may be reduced.

The semiconductor light emitting device 11 may include an n-type semiconductor layer, an active layer, a p-type semiconductor layer, an n-side electrode electrically connected to the n-type semiconductor layer, and a p-side electrode electrically connected to the p-type semiconductor layer, which are disposed on the semiconductor substrate 12 and sequentially formed thereon. The n-type and p-type semiconductor layers may be formed of a nitride semiconductor layer, for example, AlₓIn_{y}Ga_{(1-x-y)}N (0=x=1, 0=y=1, 0=x+y=1). The active layer formed between the n-type and p-type semiconductor layers may emit light having a certain amount of energy through the recombination of electrons and holes, and here, a multi quantum well structure in which a quantum well layer and a quantum barrier layer are alternately stacked, for example, an InGaN/GaN structure, may be used. The n-type and p-type semiconductor layers and the active layer configuring a light emitting structure may be grown through a process well-known in the art such as MOCVD, MBE, HVPE, or the like.

In the present embodiment, the n-type and p-type electrodes may be formed in a direction in which an upper surface of the semiconductor light emitting device is formed, and may be electrically connected to the driving circuit unit through the conductive wire 17 and receive rectified power. However, a unit for an electrode formation direction and an electrical connection is not necessarily limited thereto, and various variations thereof may be applied.

The electrode pad 16, the conductive via 15 and an extension electrode 14 may serve to provide current applied through the electrode pad 16 to the driving circuit unit.

The electrode pad 16 may be formed on a side of the substrate opposing the semiconductor light emitting device 11 having the semiconductor substrate 12 interposed therebetween, and the conductive via 15 extending from the electrode pad 16 may be formed to penetrate from a lower surface of the semiconductor substrate 12 to an upper surface thereof. The conductive via 15 may include at least one metal, such as gold (Au), silver (Ag), aluminum (Al), copper (Cu), nickel (Ni), and the like, having excellent conductivity, and may be electrically connected to the driving circuit unit, that is, the n-type or p-type semiconductor region 121 or 122 of the semiconductor substrate 12, through the extension electrode 14. In this case, an open region in which an insulator 13 is not formed may be provided in a partial region of the semiconductor substrate 12 such that the extension electrode is electrically connected to the driving circuit unit. A detailed description thereof will be provided later.

In addition, the present invention is not necessarily limited to the form of the conductive via 15 completely vertically penetrating the semiconductor substrate 12 as described above in the present embodiment, and thus, various forms may be provided according to applied embodiments. For example, the conductive via 15 may only penetrate a portion of the semiconductor substrate 12 rather than entirely penetrating therethrough so as to directly contact the n-type or p-type semiconductor region 121 or 122 in an inner portion of the semiconductor substrate 12 to thus form an electrical connection thereto. Further, the conductive via 15 may be formed to have a predetermined incline depending upon an internal configuration of the semiconductor substrate 12 or to have a shape in which a portion thereof is curved.

The insulator 13 may serve to maintain a current flow, based on a configuration of a circuit by being provided on upper, lower and lateral surfaces of the semiconductor substrate 12, between a plurality of diodes configuring the driving circuit unit, between the semiconductor light emitting device 11 and the semiconductor substrate 12, surrounding the conductive via 15, and the like, so as to insulate therebetween and therearound, by using a material having electrical insulating properties.

In the present embodiment, the semiconductor light emitting device 11 may be electrically connected to the n-type and p-type semiconductor regions 121 and 122 through the conductive wire 17, and the conductive via 15 may be electrically connected to the n-type and p-type semiconductor regions 121 and 122 through the extension electrode 14 along an upper surface of the semiconductor substrate 12. Therefore, in order to obtain this electrical connection, the insulator may be provided in a region of the upper surface of the semiconductor substrate 12 except for in a partial region thereof, such that the n-type and p-type semiconductor regions 121 and 122 may be exposed.

Subsequently, with reference to FIG. 3, in a semiconductor light emitting device package according to the present embodiment, four diodes based on the semiconductor light emitting device 11 may form a bridge circuit such that current applied from alternating current (AC) power is rectified through the bridge circuit to thus allow the semiconductor light emitting device 11 to operate.

As such, in order to configure a bridge circuit, an electrical connection may be provided between the semiconductor light emitting device 11, and the n-type and p-type semiconductor regions 121 and 122 through a wiring structure, the p-side electrode of the semiconductor light emitting device 11 may be electrically connected to two n-type semiconductor regions among the four diodes, and the n-side electrode may be electrically connected to two p-type semiconductor regions, respectively. Also, p-type semiconductor regions of two diodes in which the p-side electrode of the semiconductor light emitting device 11 is electrically connected to the n-type semiconductor region may be connected to each other, and further, n-type semiconductor regions of two diodes in which the n-side electrode of the semiconductor light emitting device 11 is electrically connected to the p-type semiconductor region may be connected to each other through the wiring structure, respectively, thereby being finally electrically connected to two electrodes of the AC current. In this case, the wiring structure may be implemented to serve a connection thereof through the bonding wire 17, and may be provided by a configuration in which a conductive metal layer is patterned on an upper surface of the semiconductor substrate 12.

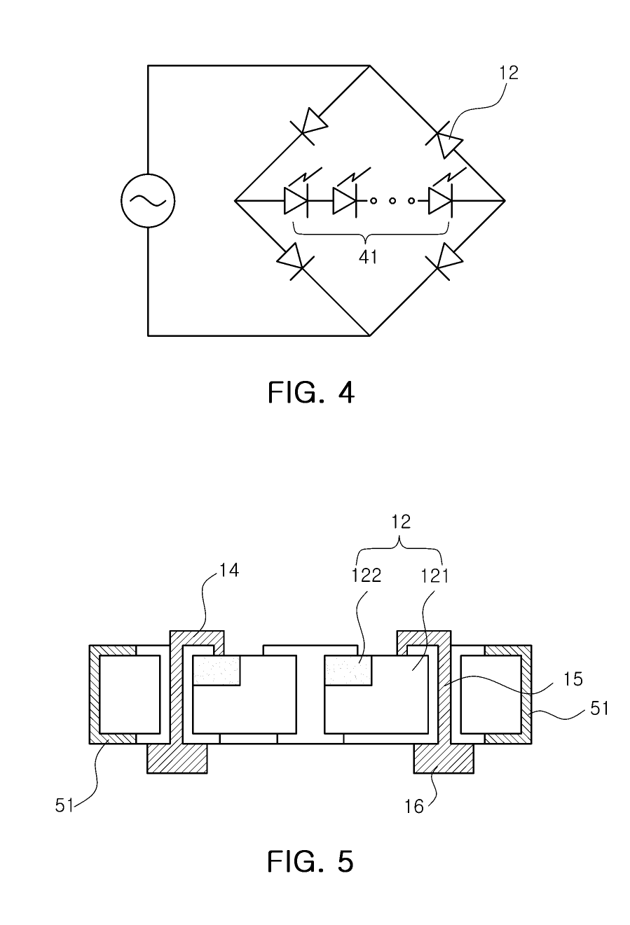

FIG. 4 is a circuit diagram schematically showing an electrical connection configuration of a semiconductor light emitting device package according to another embodiment of the present invention. With reference to FIG. 4, similar to the foregoing embodiment of the invention, a structure of a semiconductor light emitting device package including a semiconductor substrate 12, a semiconductor light emitting device 11, an electrode pad 16, a conductive via 15 and a conductive wire 17 may be provided. In this case, the same reference numerals will be used for components the same as those of FIG. 2, so a detailed description thereof will be omitted.

A difference in the configuration of the present embodiment of the invention from that of the foregoing embodiment may be in regard to a light source provided in a form in which a plurality of semiconductor light emitting devices are connected to one another in series rather than using a single semiconductor light emitting device. As such, a serial or parallel structure of a light emitting device array may be configured depending upon an amount of current applied to a single semiconductor light emitting device such that it may be used as a light source, and specifically, a plurality of light emitting devices may be mounted within a single integrated circuit, thereby significantly reducing the overall size of the package.

FIG. 5 is a schematic cross-sectional view of a semiconductor light emitting device package according to another embodiment of the present invention. With reference to FIG. 5, similar to the foregoing embodiment, a semiconductor light emitting device package according to another embodiment of the present invention may include a semiconductor substrate 12, a semiconductor light emitting device 11, an electrode pad 16, a conductive via 15 and a conductive wire 17, and further, a reflective layer 51 instead of an insulating layer may be formed on a portion of the surface of the semiconductor substrate 12. In this case, the same reference numerals will be used for components the same as those of FIG. 2, so a detailed description thereof will be omitted.

In this case, the reflective layer 51 may be formed of a metal having relatively high light reflectivity, for example, of at least one of Ag, Au, Al, Cu, and Ni. As described above, in the case in which the reflective layer 51 is formed on a substrate surface, when light emitted from the active layer of the semiconductor light emitting device moves toward the semiconductor substrate 51, the reflective layer 51 may reflect light to thereby increase light extraction efficiency. However, in a case in which a material forming the reflective layer 51 has electrical conductivity, the reflective layer may be formed at an appropriate position in which the circuit configuration in an inner portion of the semiconductor substrate 12 may not be affected thereby. That is, in the case of the conductive via 15, the n-type and p-type semiconductor regions, with regard to a region to being electrically isolated from another region of the semiconductor substrate 12, the reflective layer may not be formed, but the insulating layer 13 may be formed.

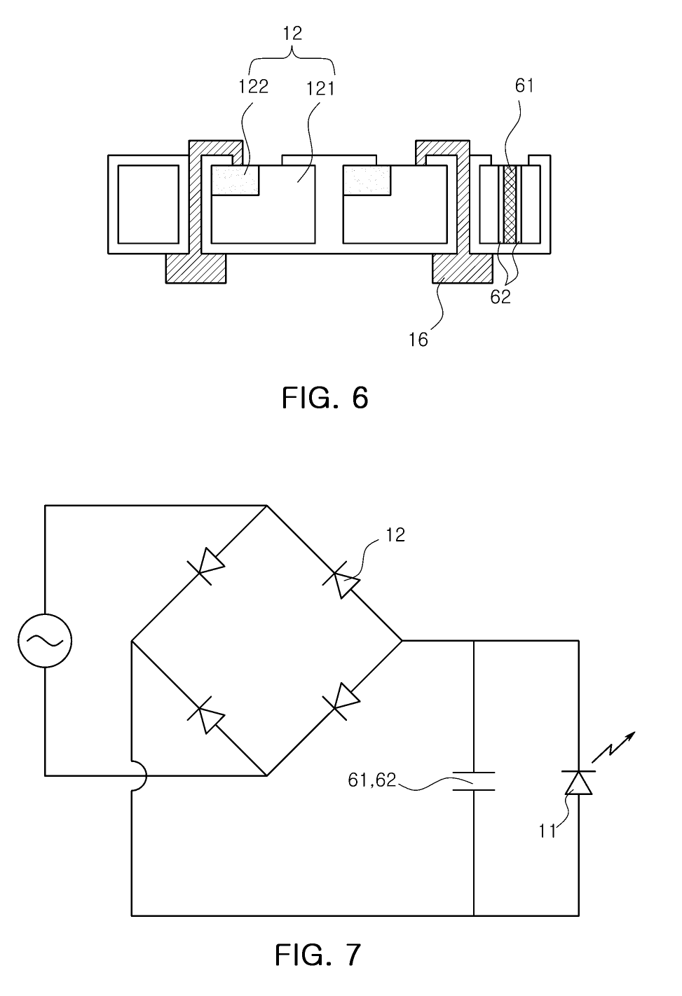

FIG. 6 is a schematic cross-sectional view of a semiconductor light emitting device package according to another embodiment of the present invention. FIG. 7 is a circuit diagram schematically showing an electrical connection relationship between internal parts in the semiconductor light emitting device package of FIG. 6. With reference to FIGS. 6 and 7, similar to the foregoing embodiment, a semiconductor light emitting device package according to another embodiment of the present invention may include a semiconductor substrate 12, a semiconductor light emitting device 11, an electrode pad 16, a conductive via 15, and a conductive wire 17, while a capacitor (61, 62) may be formed on a partial region of the semiconductor substrate 12. In this case, the same reference numerals will be used to denote components the same as those of FIG. 2, so a detailed description thereof will be omitted.

The capacitor (61, 62) according to the present embodiment may be obtained by forming a dielectric layer 61 in a partial region of the semiconductor substrate 12 in a thickness direction thereof and by disposing conductive layers 62 on both surfaces of the dielectric layer 61 to be parallel to each other. In addition, a region in which the capacitor (61, 62) is formed is not particularly limited, but the region may be provided in a form in which it is separated from another region of the semiconductor substrate 12 via the insulator 13, and may also be connected to the light source in parallel as shown in FIG. 7. In the present embodiment, since AC current may be used as power, the point in time that an inverse current is supplied to the light source may be present. However, flickering due to inverse current may be prevented by using the capacitor as described above.

In this case, capacitance of the capacitor (61, 62) may be different according to a material forming the dielectric layer 61 and a distance between the conductive layers 62, and although current supplied to the light source may be uniformly maintained by forming a relatively large capacity in the capacitor (61, 62), a capacitor having an appropriate capacitance in consideration of the overall size of the semiconductor light emitting device package and several conditions in a production process may be provided.

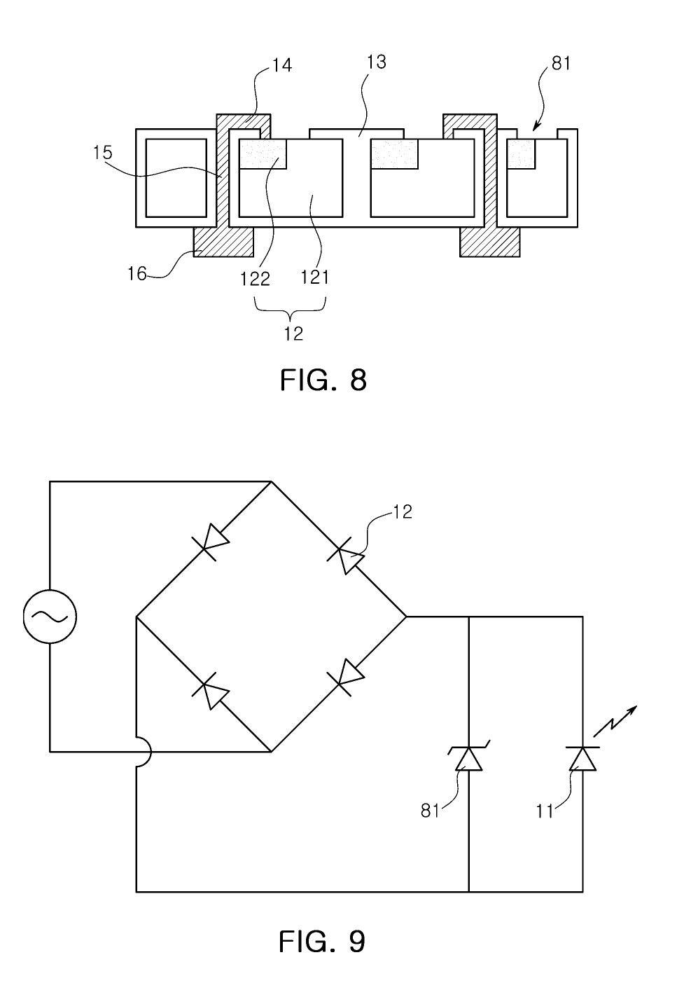

FIG. 8 is a schematic cross-sectional view of a semiconductor light emitting device package according to another embodiment of the present invention. FIG. 9 is a circuit diagram schematically showing an electrical connection relationship between internal parts of a semiconductor light emitting device package of FIG. 8. With reference to FIGS. 8 and 9, similar to the foregoing embodiment, a semiconductor light emitting device package according to the present embodiment may include a semiconductor substrate 12, a semiconductor light emitting device 11, an electrode pad 16, a conductive via 15 and a conductive wire 17, and further, a zener diode 81 may be formed on a partial region of the semiconductor substrate 12. In this case, the same reference numerals will be used for components the same as those of FIG. 2, so a detailed description thereof will be omitted.

The zener diode 81 according to the present embodiment may be configured of one pair of diffusion layers obtained by implanting n-type and p-type impurities into a partial region of the semiconductor substrate 12 to thus be diffused, and in this regard, may be provided in a similar form to that of a diode provided in an inner portion of the semiconductor substrate 12. As such, voltage resistance properties of light emitting devices may be complemented by forming a zener diode and connecting the zener diode to the light source in parallel as shown in FIG. 9.

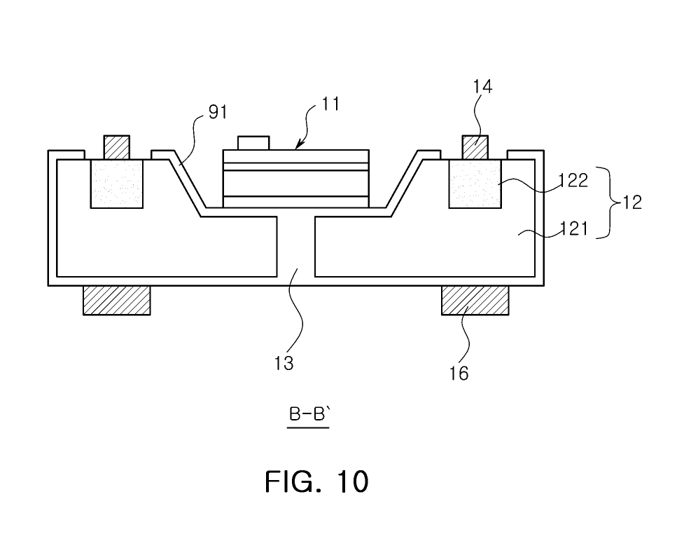

FIG. 10 is a schematic cross-sectional view of a semiconductor light emitting device package according to another embodiment of the present invention. With reference to FIG. 10, similar to the foregoing embodiment, a semiconductor light emitting device package according to the present embodiment may include a semiconductor substrate 12, a semiconductor light emitting device 11, an electrode pad 16, a conductive via 15 and a conductive wire 17. Further, the semiconductor substrate 12 may include a cavity 101 formed to have a form in which a portion thereof has been removed from an upper surface thereof, and the semiconductor light emitting device 11 may be disposed in the cavity 101. In FIG. 10, the semiconductor light emitting device 11 and a shape of the cavity formed in the semiconductor substrate 12, which are relatively important constituent elements in the present embodiment may be precisely represented; unlike the foregoing embodiment, another surface of the semiconductor light emitting device is shown to be cut (for example, in the case of FIG. 1, being cut along line B-B′ perpendicular thereto, not a cross-section taken along line A-A′ as described in the foregoing embodiment). In this case, it should be noted that FIGS. 1 and 10 provide different embodiments, and line BB′ shown in FIG. 1 is only an example in which it may be possible to cut in this direction.

As the semiconductor light emitting device 11 is disposed in a region of the cavity 101 of the semiconductor substrate 12, a distance from the second principal surface of the semiconductor substrate 12 may be relatively reduced, and therefore, the present embodiment may have strengths in view of a radiation as compared to the foregoing embodiment, and although not shown in the drawings, a via shaped radiation unit penetrating a substrate may be further formed in order to increase a radiation effect.

In addition, although not shown in the drawings, the reflective layer 11 reflecting light emitted from the semiconductor light emitting device 11 to induce the light to be directed upwardly may be provided with an inner wall of the cavity, and through this structure, an angle light spread to be required according to control thereof may be obtained. Also, the reflective layer may be formed of a conductive metal such as Ag, Au, Al, Cu, Ni, or the like, such that the semiconductor light emitting device 11 may have a connection structure with the driving circuit unit through a reflection unit.

As set forth above, according to an embodiment of the present invention, a semiconductor light emitting device package having a small sized and integrated structure may be obtained by disposing a driving circuit in a substrate inside, whereby fabrication costs and defective rates of the semiconductor light emitting device package may be reduced while being used with alternating current (AC) power.

While the present invention has been shown and described in connection with the embodiments, it will be apparent to those skilled in the art that modifications and variations can be made without departing from the spirit and scope of the invention as defined by the appended claims.

What is claimed is:

1. A semiconductor light emitting device package comprising:
a semiconductor substrate having a first principal surface and a second principal surface opposed thereto;
a light source disposed on a first principal surface side of the semiconductor substrate;
a plurality of electrode pads disposed on a second principal surface side of the semiconductor substrate;
a conductive via extended from the plurality of electrode pads and penetrating the semiconductor substrate from the second principal surface thereof to the first principal surface thereof; and
a driving circuit unit including a plurality of diodes obtained through a pn junction formed by a p-type region having a relatively high concentration of a p-type impurity and an n-type region having a relatively high concentration of an n-type impurity, and electrically connected to the conductive via and the light source to thus rectify an alternating current (AC) current flowing through the plurality of electrode pads and supply the rectified current to the light source.

2. The semiconductor light emitting device package of claim 1, wherein all regions of the semiconductor substrate are formed of the n-type region except for the p-type region thereof.

3. The semiconductor light emitting device package of claim 1, wherein in the semiconductor substrate, at least a portion thereof, except for the p-type region, is a region not doped with an impurity.

4. The semiconductor light emitting device package of claim 1, wherein at least a portion of a surface of the semiconductor substrate is provided with a reflective layer reflecting at least a portion of light emitted from the light source.

5. The semiconductor light emitting device package of claim 4, wherein the reflective layer is formed on a surface of the semiconductor substrate, except for in a region in which an insulator is formed.

6. The semiconductor light emitting device package of claim 1, wherein at least part of the plurality of diodes is exposed to the outside through the first principal surface.

7. The semiconductor light emitting device package of claim 1, wherein at least portions of the plurality of diodes are electrically connected to one another through a wiring structure provided on the first principal surface of the semiconductor substrate.

8. The semiconductor light emitting device package of claim 1, wherein the light source is a light emitting device including an n-type semiconductor layer, a p-type semiconductor layer, an active layer interposed therebetween, an n-side electrode electrically connected to the n-type semiconductor layer, and a p-side electrode electrically connected to the p-type semiconductor layer.

9. The semiconductor light emitting device package of claim 1, wherein the n-side electrode is electrically connected to at least one p-type region of the plurality of diodes, and the one p-side electrode is electrically connected to at least one n-type region of the plurality of diodes.

10. The semiconductor light emitting device package of claim 1, wherein the n-side and p-side electrodes and the diodes are electrically connected to each other through the wiring structure provided on the first principal surface of the semiconductor substrate.

11. The semiconductor light emitting device package of claim 1, wherein the light source includes a plurality of semiconductor light emitting devices electrically connected to one another.

12. The semiconductor light emitting device package of claim 11, wherein the plurality of semiconductor light emitting devices are mounted within a single integrated circuit.

13. The semiconductor light emitting device package of claim 1, wherein the semiconductor substrate includes at least one of Si and SiC.

14. The semiconductor light emitting device package of claim 1, wherein the semiconductor substrate includes an insulator formed on at least a portion of the surface thereof.

15. The semiconductor light emitting device package of claim 1, further comprising an insulator interposed between the semiconductor substrate and the conductive via.

16. The semiconductor light emitting device package of claim 1, further comprising an insulator penetrating the semiconductor substrate in a thickness direction thereof to separate between the plurality of diodes.

17. The semiconductor light emitting device package of claim 1, further comprising a capacitor unit including a dielectric layer formed in an inner portion of the semiconductor substrate and connected to the light source in parallel.

18. The semiconductor light emitting device package of claim 17, wherein the capacitor unit is spaced apart from another region of the semiconductor substrate via an insulating layer.

19. The semiconductor light emitting device package of claim 17, wherein the capacitor unit and the light source are electrically connected to each other through the wiring structure provided on the first principal surface.

20. The semiconductor light emitting device package of claim 1, further comprising an electrostatic discharge protection circuit connected to the light source in parallel.

21. The semiconductor light emitting device package of claim 20, wherein the electrostatic discharge protection circuit includes a zener diode formed in the inner portion of the semiconductor substrate.

22. The semiconductor light emitting device package of claim 21, wherein the zener diode is spaced apart from another region of the semiconductor substrate by the insulating layer.

23. The semiconductor light emitting device package of claim 1, wherein the semiconductor substrate includes a cavity having a form in which a portion thereof has been removed from the first principal surface, and the light source is disposed in the cavity.

24. The semiconductor light emitting device package of claim 23, further comprising a reflective layer formed on an inner wall of the cavity.

25. The semiconductor light emitting device package of claim 24, wherein the cavity has a width increased away from the first principal surface.
